(19) United States
(12) Patent Application Publication
(10) Pub. No.: US 2002/0041790 A1
(43) Pub. Date: Apr. 11, 2002

(54) Joining structure for two members, and propeller shaft

(76) Inventors: Koya Suzuki, Aichi-ken (JP); Yasuki Miyashita, Aichi-ken (JP); Yoshiharu Yasui, Aichi-ken (JP); Masaaki Amano, Aichi-ken (JP); Toshiro Kondo, Aichi-ken (JP); Junji Takeuchi, Aichi-ken (JP); Yasunori Nonogaki, Aichi-ken (JP)

Correspondence Address: MORGAN & FINNEGAN, L.L.P., 345 Park Avenue, New York, NY, 10154, US

(21) Appl. No.: 09/972,448

(22) Filed: Oct. 6, 2001

(30) Foreign Application Priority Data
Oct. 10, 2000 (JP) 2000-308968
Oct. 26, 2000 (JP) 2000-327176
Aug. 15, 2001 (JP) 2001-246491

(51) Int. Cl. F16B 1/00; B25G 3/28; F16G 11/00

(52) U.S. Cl. 403/280

(57) ABSTRACT

A step portion is provided between a serration portion of a metal-made yoke and a leading end portion thereof. During pressure insertion and joining, an FRP-made cylinder is pressure-inserted to the serration portion in a state that the circularity is enhanced by the step portion. Consequently, the pressure insertion and joining is carried out while making the depth of cut grooves uniform, thereby enhancing concentricity (joining accuracy).

### BACKGROUND OF THE INVENTION

1. Field of the Invention

The present invention relates to a joining structure for members, and more particularly to a joining structure for a metal-made yoke and an FRP-made cylinder in a propeller shaft. Further, the present invention relates to a propeller shaft having two shaft portions one of which is inserted into the other.

2. Description of the Related Art

An automotive propeller shaft is disposed between a transmission and a differential device to transmit the torque. Accordingly, to have strength against torsion and bending and to be reduced in weight, a propeller shaft made of fiber reinforced plastic (FRP) has been developed recently. Another important aspect, in addition to securing the strength and the weight reduction, is to secure safety of passengers when the automotive vehicle collides. The recent design concept for automotive vehicles, therefore, lies in that the body is designed to be crushable to absorb impact energy at collision through compressive breakage of the body, thereby suppressing the impact reaching the passengers. In view of this concept, the propeller shaft is constructed by at least two shaft portions one of which is inserted into the other, so that, at collision, the one shaft portion is deeply retracted into the other shaft portion to shorten the shaft length, thereby avoiding the interference with the compressive breakage of the body.

As shown in FIGS. 21 and 22, a propeller shaft 1 includes a FRP cylinder 2, as a second member, which is made up of a cylindrical member formed of FRP, and a metal yoke 3, as a first member, which is formed of metal and inserted into the FRP cylinder 2. Next, the connection between the FRP cylinder 2 and the metal yoke 3 will be discussed. Serration teeth 4 are provided on the outer circumferential surface of the insertion portion of the metal yoke 3 to be elongated substantially in the insertion direction. The diameter of the insertion portion of the metal yoke 3 at the teeth tips of the serration teeth 4 is slightly larger than the hole diameter concerning the inner circumferential surface of the FRP cylinder 2. Accordingly, when the metal yoke is pressure-inserted into the FRP cylinder 2, the metal yoke 3 enters the cylinder while enlarging the FRP cylinder 2. Concurrently, the serration teeth 4 of the metal yoke 3 enter while cutting the inner circumferential surface of the FRP cylinder 2. Consequently, grooves 5 of such a shape as to engage the serration teeth 4 are formed on the inner circumferential surface of the FRP cylinder 2. With the propeller shaft 1 thus constructed, the FRP cylinder 2 and the metal yoke 3 transmit the torque through the serration teeth 4 and the grooves engaged therewith, and at collision, the metal yoke 3 is deeply retracted into the FRP cylinder 2 while enlarging the FRP cylinder 2 to shorten the entire length of the propeller shaft 1, thereby absorbing the impact.

In general, the propeller shaft is to transmit the power of a drive source, such as an engine, in an automotive vehicle, and as mentioned above, it is constructed by the metal-made yoke coupled to the mission, the differential or the like, and the FRP made cylinder joined to the metal-made yoke. A purpose of adopting the FRP-made member, i.e. a resin member, is to reduce the weight of the propeller shaft, thereby raising the resonance point of the shaft, and reducing the total weight of the automotive vehicle.

The FRP-made cylinder is manufactured by a filament winding process or the like as disclosed in Japanese Patent Application Laid-open No. 2000-108213. According to this process, fiber bundles impregnated with resin are wound onto a mandrel, and then the resin is cured, and thereafter the mandrel is removed to provide a product.

However, the aforementioned related art suffers from the following problem. In general, the FRP made cylinder inner circumferential surface is contacted with the mandrel as can be seen in the aforementioned process, and thus it is a true circle, but the circularity of the FRP-made cylinder after molding frequently contains error strictly. One of the reasons is that since the thickness of the FRP-made cylinder contains error (variation) some or less due to winding and molding, the error in thickness of the FRP-made cylinder influences the contraction when the FRP-made cylinder is contracted during the curing of the resin to cause the strain some or less on the its inner circumferential surface. If the metal-made yoke is pressure-inserted into such FRP-made cylinder, they are jointed together along a chamfered portion of the leading end of the metal-made yoke in a state that the FRP-made cylinder still does not have accurate circularity. This results in that the depth of the cut grooves formed in the FRP-made cylinder inner circumferential surface by the serration portions provided to the metal-made yoke outer circumferential surface is non-uniform in the circumferential direction, and thus the metal-made yoke and the FRP-made cylinder are joined together in an eccentric state.

If the depth of the cut grooves is non-uniform in the circumferential direction, the load applied to each serration portion of the propeller shaft is non-uniform, and the serration portion to which the excessive load is applied may be broken. Further, the propeller shaft is designed, as a countermeasure at the vehicle collision, to be shortened in its entire length by retracting the metal-made yoke into the FRP-made cylinder with the load generated by the vehicle collision, the load required for retraction may be varied product by product.

Furthermore, if the propeller shaft is driven in the state that the metal-made yoke and the FRP-made cylinder are joined together eccentrically, the propeller shaft may be vibrated to cause the resonance or breakage.

Moreover, since, in general, and in many cases, the propeller shaft is assembled not in parallel to a central axis in the width direction of the automotive vehicle, even if the impact load acts in parallel to the central axis of the automotive vehicle, the direction in which the impact load acts on the propeller shaft is inclined with respect to the propeller shaft axis direction. In this case, as shown in FIGS. 21 and 22, the component of the impact load in the central axis direction causes the metal-made yoke 3 to be retracted into the FRP-made cylinder 2, but the component of the impact load in the direction normal to the central axis causes a moment M for rotating the metal-made yoke 3. Consequently, the metal yoke 3 is retracted into the FRP-made cylinder 2 while being inclined, and as a result, although a smaller retracting force is desirable to more efficiently absorb the impact load, the leading ends of the inclined serration teeth 4 are strongly forced to cut the inner surface of the FRP-made cylinder 2 to thereby increase the retracting force.

### SUMMARY OF THE INVENTION

Accordingly, the present invention has been made in view of the above-mentioned problems inherent in the related art, and an object thereof is to provide a joining structure made up of at least two members, which can accurately insert a first member having serration portions into a second member.

Further, the present invention is purposed to provide a propeller shaft high in joining accuracy (concentricity) and thus a joining structure of high joining accuracy, by making uniform the depth of the cut grooves when a FRP-made cylinder is joined to a metal-made yoke.

Moreover, another object of the present invention is to provide a propeller shaft, which can prevents the increase of retraction force even if impact load acts obliquely with respect to a shaft central axis.

In order to attain the above-noted object, according to a first aspect of the present invention, the invention is directed to a joining structure comprising: a first member having a serration portion; and a second member to be joined to the serration portion, wherein the first member has a surface contact portion at location adjacent to the serration portion to be surface-contacted with the second member.

According to this structure, when the serration portion of the first member is joined to the second member, the surface contact portion of the first member is surface-contacted with the second member. Consequently, they are joined with high concentricity.

According to a second aspect of the present invention, the serration portion is provided at a pressure insertion end portion of the first member; the second member has a pressure insertion portion to be pressure-inserted and joined to the serration portion; the surface contact portion includes a step portion provided between a leading end portion of the pressure insertion end portion and the serration portion to extend in an axial direction; and a diameter of the step portion is equal to a diameter of the pressure insertion portion or set between the diameter of the pressure insertion portion and a diameter of the serration portion.

According to this structure, when the first member is joined to the second member, the pressure insertion portion of the second member is formed by the step portion of the first member into a true circle, and the depth of cut grooves formed by the serration portion is made uniform, and the second member is joined to the serration portion in this state.

According to a third aspect of the present invention, the serration portion is provided to an outer circumferential surface of the pressure insertion end portion; the pressure insertion portion of the second member is hollow; and an outer diameter of the step portion is not smaller than an inner diameter of the pressure insertion portion, and is smaller than an outer diameter of the serration portion.

According to this structure, the serration portion on the outer circumferential surface of the first member is joined to the second member.

According to a fourth aspect of the present invention, the pressure insertion end portion of the first member is hollow; the serration portion is provided to an inner circumferential surface of the first member; and an inner diameter of the step portion is not larger than an outer diameter of the pressure insertion portion, and is larger than an inner diameter of the serration portion.

According to this structure, the serration portion on the inner circumferential surface of the first member is joined to the second member.

According to a fifth aspect of the present invention, the first member is a metal member; and the second member is a resin member.

According to this structure, since the metal member is joined to the resin member, the joining member as a whole is reduced in weight in comparison to a case where it is constructed solely by a metal member.

According to a sixth aspect of the present invention, after the second member is joined to the serration portion of the first member, the step portion is in non-contact with the second member.

According to this structure, the step portion does not resist against the pressure insertion during joining of the members and the retraction in case of the vehicle collision.

According to a seventh aspect of the present invention, a chamfering portion is provided to the first member to extend from the leading end portion to the step portion.

According to this structure, the resistance at the pressure insertion end portion during the pressure insertion process is small.

According to an eighth aspect of the present invention, the step portion is connected to the serration portion through an inclined surface.

According to this structure, by setting an appropriate angel for the inclined surface, as the pressure insertion advances from the step portion to the serration portion, cut grooves are formed by the serration portion while the step portion and the second member are gradually spaced from each other.

According to a ninth aspect of the present invention, the step portion is connected to the serration portion through an inclined surface; and a relief portion in the form of a recess is provided to a connection portion between the inclined surface and the step portion.

According to this structure, during the formation process of the inclined surface, a leading end of a cutting tool of lathe can escape into the relief portion to form the inclined surface with a desired angle.

According to a tenth aspect of the present invention, the step portion is tapered so that the outer diameter of the step portion is made smaller toward the leading end portion.

According to this structure, the resistance at the step portion during the pressure insertion is small.

According to an eleventh aspect of the present invention, the step portion is tapered so that the inner diameter of the step portion is made larger toward the leading end portion.

According to this structure, the resistance at the step portion during the pressure insertion is small.

According to a twelfth aspect of the present invention, the serration portion is tapered so that the outer diameter of the serration portion is made smaller toward to the leading end portion.

According to this structure, the resistance at the serration portion during the pressure insertion is small.

According to a thirteenth aspect of the present invention, the joining structure of the fourth aspect of the invention is such that the serration portion is tapered so that the inner diameter of the serration portion is made larger toward the leading end portion.

According to this structure, the resistance at the serration portion during the pressure insertion is small.

According to a fourteenth aspect of the present invention, the step portion is formed by partially removing addendum portions of the serration portion.

According to a fifteenth aspect of the present invention, the step portion is formed cylindrically between the leading end portion and the serration portion.

According to a sixteenth aspect of the present invention, a propeller shaft is provided, in which the first member is a metal-made yoke; and the second member is an FRP-made cylinder.

According to a seventeenth aspect of the present invention, a propeller shaft has the joining structure according to the first aspect of the invention, in which the second member has a hollow portion at an end portion, and the first member is inserted into the hollow portion, wherein: the serration portion is provided to an outer circumferential surface of an insertion portion of the first member; grooves are provided to an inner circumferential surface of the hollow portion to engage the serration portion; and the surface contact portion includes an inclination suppressing surface that is provided on the outer circumferential surface of the insertion portion and behind the serration portion in an insertion direction, and that is surface-contacted with the inner circumferential surface of the hollow portion to suppress an inclination of the first member during insertion.

According to this structure, even if the inclined impact load is applied, the inner circumferential surface of the second member and the inclination suppressing surface of the first member are surface-contacted with each other behind the serration teeth in the insertion direction, to thereby suppress the inclination of the first member.

According to an eighteenth aspect of the present invention, two first and second serration portions are provided to be spaced in the insertion direction; and the inclination suppressing surface is provided behind either one or both of the first serration portion located forwardly in the insertion direction and the second serration portion located rearward in the insertion direction.

According to a nineteenth aspect of the present invention, the surface contact portion includes a guide surface that is provided to the outer circumferential surface of the insertion portion at its forward end and forwardly of the serration portion in the insertion direction, and that is surface-contacted with the inner circumferential surface of the hollow portion to ensure concentricity of shaft members during start of insertion.

According to a twentieth aspect of the present invention, the guide surface and the inclination suppressing surface are substantially equal to each other in diameter.

### BRIEF DESCRIPTION OF THE DRAWINGS

FIG. 1 is a view showing the entire structure of a propeller shaft according to a first embodiment.

FIG. 2 is a partial sectional view showing a joining portion of the propeller shaft according to the first embodiment.

FIG. 3 is a partial sectional view showing the joining portion for explaining a pressure-insertion joining action according to the first embodiment.

FIG. 4 is a partial sectional view showing the joining portion for explaining the pressure-insertion joining action according to the first embodiment.

FIG. 5 is a partial sectional view showing the joining portion for explaining the pressure-insertion joining action according to the first embodiment.

FIG. 6 is a perspective view showing a step portion and a serration portion according to the first embodiment.

FIG. 7 is a perspective view showing a step portion and a serration portion according to a second embodiment.

FIG. 8 is a partial sectional view showing a joining portion between two members according to the second embodiment.

FIG. 9 is a partial sectional view showing the joining portion for explaining the pressure-insertion joining action according to the second embodiment.

FIG. 10 is a partial sectional view showing the joining portion for explaining the pressure-insertion joining action according to the second embodiment.

FIG. 11 is a sectional view showing a propeller shaft according to a third embodiment of the present invention.

FIG. 12 is an enlarged view of II portion of FIG. 11.

FIG. 13 is a perspective view showing a serration tooth of a metal yoke and vicinities thereof according to the third embodiment of the present invention.

FIG. 14 is a sectional view taken along a line IV-IV of FIG. 12.

FIG. 15 is a sectional view taken along a line V-V of FIG. 12.

FIG. 16 is a perspective view showing a serration tooth of a metal yoke and vicinities thereof according to a fourth embodiment of the present invention.

FIG. 17 is a perspective view showing a serration tooth of a metal yoke and vicinities thereof according to a fifth embodiment of the present invention.

FIG. 18 is perspective view showing a serration tooth of a metal yoke and vicinities thereof according to a sixth embodiment of the present invention.

FIG. 19 is a perspective view of a serration tooth of a metal yoke and vicinities thereof according to a seventh embodiment of the present invention.

FIG. 20 is a perspective view showing a serration tooth of a metal yoke and vicinities thereof according to an eighth embodiment of the present invention.

FIG. 21 is a sectional view showing a propeller shaft of a related art.

FIG. 22 is an enlarged view of XII portion of FIG. 21.

### DESCRIPTION OF THE PREFERRED EMBODIMENTS

Hereafter, embodiments of this invention will be described with reference to the accompanying drawings.

First Embodiment

FIG. 1 shows the entire view of a propeller shaft 110. The propeller shaft 110 is of a joining member in which metal-made yokes 101, i.e. first members, are respectively pressure-inserted and joined to ends of a FRP-made cylinder 102, i.e. a second member.

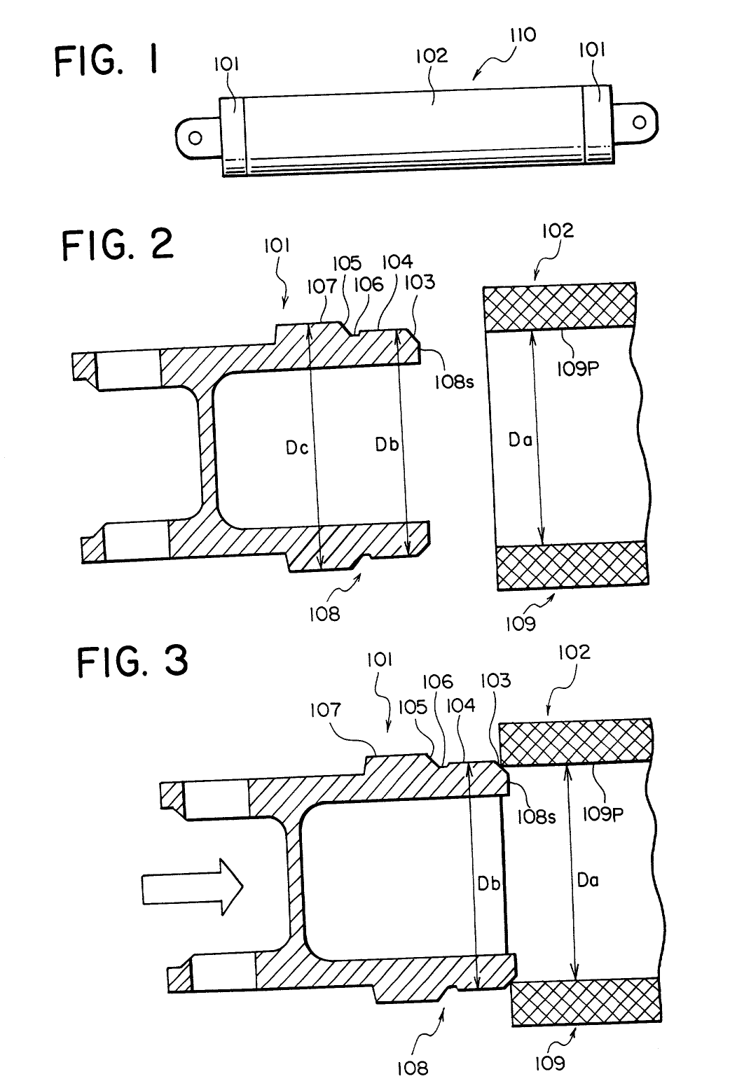

As shown by a partial sectional view showing a joining portion in FIG. 2, the metal-made yoke 101 is provided at its one end with a pressure-insertion end portion 108 to be joined to the FRP-made cylinder, and the leading end thereof is a leading end portion 108s. A step portion 104 is provided to extend in an axial direction from the leading end portion 108s. A chamfering portion 103 is provided by chamfering from the leading end portion 108s to the step portion 104. A serration portion 107 is provided to extend in the axial direction further from the step portion 104.

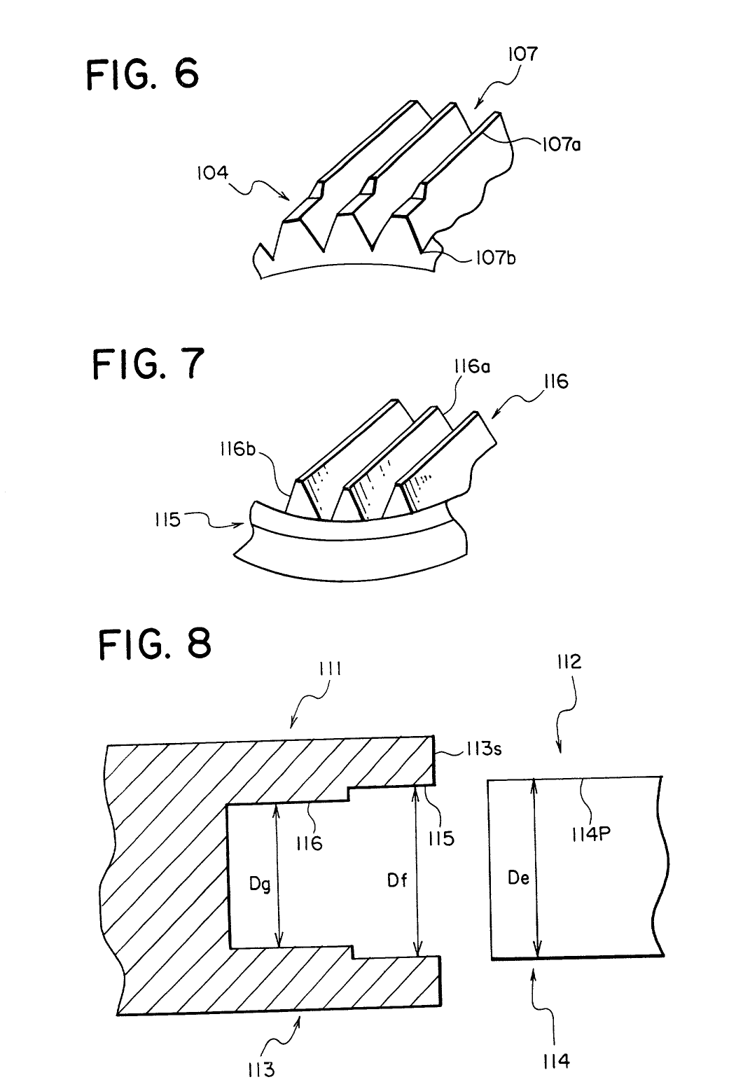

As shown in FIG. 6, the serration portion 107 is made up of addendum portions 107a and deddendum portions 107b, and the step portion 104 is formed by cutting the addendum portions 107a of the serration portion 107 so that continuous lines on the outer shape of the cut portions are cylindrical.

On the other hand, the FRP-made cylinder 102 forms a hollow portion entirely, and is provided at its left and right ends with pressure-insertion portions 109 to which the metal-made yokes 101 are to be joined, respectively.

The relationship between a dimension Db of the outer diameter of the step portion 104 and a dimension Da of the inner diameter of the pressure-insertion portion 109 of the FRP-made cylinder 102 is Db≧Da. As far as the dimension Db of the outer diameter of the step portion 104 is not smaller than the dimension Da of the inner diameter of the pressure insertion portion 109 of the FRP-made cylinder 102 prior to the pressure insertion, the pressure insertion portion inner circumferential surface 109P of the FRP-made cylinder 102 can be formed into a true circle by the step portion 104 during the pressure insertion.

Further, the relationship between the dimension Db of the outer diameter of the step portion 104 and an outer diameter dimension Dc of the serration portion 107 is Db<Dc. As far as the dimension Dc of the outer diameter of the serration portion 107 is larger than the dimension Db of the outer diameter of the step portion 104, cut grooves can be formed in the pressure insertion portion inner circumferential surface 109P of the FRP-made cylinder 102 by the serration portion.

The step portion 104 and the serration portion 107 are connected together by an inclined surface 105 having an inclined angle of 45 degrees. (The inclined angle of the inclined surface 105 should not be limited to 45 degrees, and may be selected to be an appropriate angle to exhibit such an effect that as the pressure insertion of the serration portion 107 advances, the step portion 104 is more distanced from the pressure insertion portion inner circumferential surface 109P of the FRP-made cylinder 102.)

The connection portion between the slope surface 105 and the portion 104 is formed with a relief portion 106 that is a recess C-shaped in section. (During a process for forming the metal-made yoke 101, the inclined surface 105 is formed by a cutting tool of a lathe machine. By forming the relief portion 106 into which the leading end of the cutting tool enters, it is possible to accurately form the inclined angle between the inclined surface and the step portion 104. The shape of the relief portion should not be limited to the C-shape in section but may be a U-shape or a V-shape as long as the leading end of the cutting tool can escape into the relief portion 106 during the process of forming the metal-made yoke 101.)

Next, a process of pressure-inserting and joining metal-made yoke 101 into the FRP-made cylinder 102 will be discussed with reference to FIGS. 3 to 5.

As shown in FIG. 3, at a first pressure insertion step, the pressure insertion is carried out such that the FRP made cylinder 102 is guided by the chamfered portion 103 of the metal-made yoke 101 while the dimension Da of the inner diameter of the pressure insertion portion 109 is enlarged.

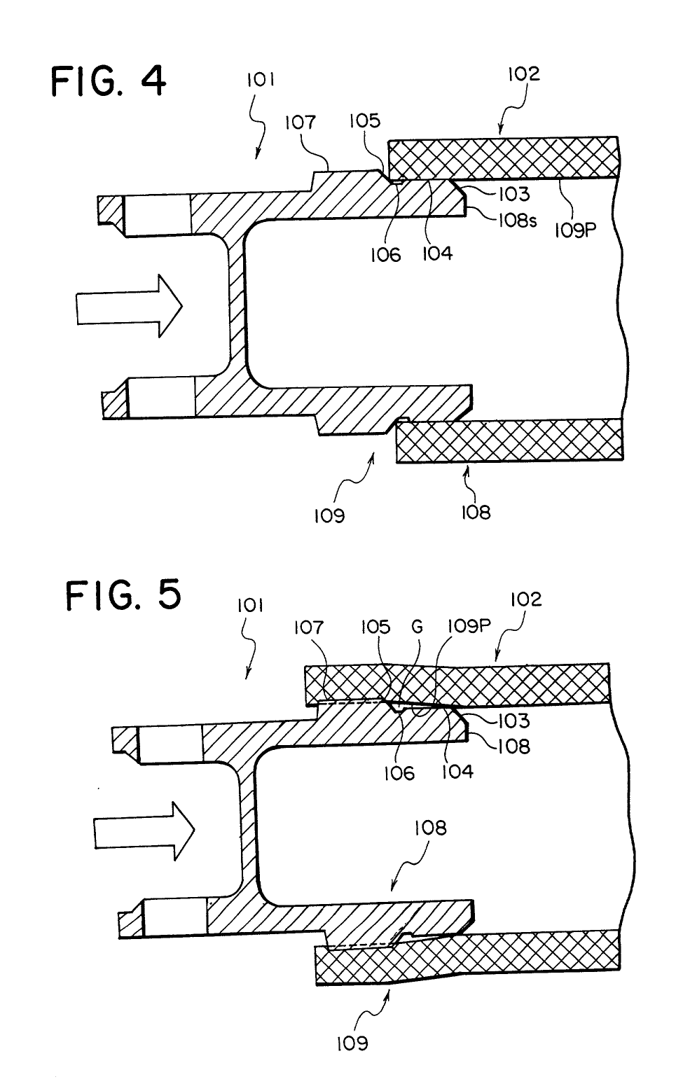

Subsequently, as shown in FIG. 4, at a second pressure insertion step, the FRP-made cylinder 102 is pressure-inserted to reach the step portion 104, and the pressure insertion portion inner circumferential surface 109P of the FRP-made cylinder 102, which is low in circularity, is enlarged by the step portion 104, whose continuous lines on the outer shape are cylindrical, to be formed into a true circle.

Further, as shown in FIG. 5, at a third pressure insertion step, the pressure insertion portion inner circumferential surface 109P of the FRP-made cylinder 102 is pressure-inserted to the serration portion 107 while being cut by the addendum portions 107a of the serration portion 107, so that cut grooves are formed in the pressure insertion portion inner circumferential surface 109P of the FRP-made cylinder 102, whereby the pressure insertion joining is complete. During the pressure insertion, cut particles are generated as a consequence of cutting of the pressure insertion portion inner circumferential surface 109P by the serration portion 107, but since the relief portion 106 is formed between the inclined surface 105 and the step portion 104 in the metal-made yoke 101, the cut particles are accumulated and escaped into the relief portion 106, thereby being prevented from remaining between the serration portion 107 and the pressure insertion portion. Accordingly, it is possible to suppress the increase in the pressure insertion load caused due to the remaining cut particles.

During the pressure insertion to the serration portion 107 at the third pressure insertion step, the pressure insertion is carried out such that the pressure insertion portion inner circumferential surface 109P is guided by the inclined surface 105, while the inner diameter dimension Da of the pressure insertion portion 109 of the FRP-made cylinder 102 is enlarged. Accordingly, a gap G is formed between the pressure insertion portion inner circumferential surface 109P and the step portion 104. Consequently, the pressure insertion portion inner circumferential surface 109P of the FRP-made cylinder 102 is made in non-contact with the step portion 104. (Even if contacted, the contact pressure is extremely low.) Further, the outer diameter Db of the step portion 104 is set to be substantially equal to or slightly larger than the dimension Da of the inner diameter of the pressure insertion portion 109, and in this embodiment a difference between the outer diameter Db and the dimension Da of the inner diameter is set to be 0 to 0.1 mm. Accordingly, the pressure insertion portion 109 is conformed to the step portion 104 to be formed into the true circle, and then the serration portion 107 can be pressure-inserted and joined. For this reason, it is possible to make uniform the depth of the cut grooves formed in the FRP-made cylinder 102 inner surface, thereby eliminating the eccentricity.

Next, the effects of the present embodiment will be described.

(1) According to the present embodiment, when the metal-made yoke 101, i.e. the first member, and the FRP-made cylinder 102, i.e. the second member, are joined, the pressure insertion portion inner circumferential surface 109P of the FRP-made cylinder 102, i.e. the hollow member, is joined to the serration portion 107 such that the pressure insertion portion inner circumferential surface 109P is formed by the step portion 104 of the metal-made yoke 101 into the true circle, and the depth of the cut grooves formed by the serration portion 107 is made uniform. Therefore, it is possible to realize a joining structure high in joining accuracy.

(2) The FRP-made cylinder 102 is jointed to the serration portion 107 provided to the outer circumferential surface of the metal-made yoke 101. That is, a joining structure for two members, i.e. one first member provided at its outer circumferential surface with the serration portion 107 and the other second member, is realized.

(3) It is possible to provide a light-weight joining member as a whole since the metal-made yoke 101, i.e. a metal member, is joined to the FRP-made cylinder 102, i.e. a resin member. Further, the expansion/contraction property of the resin member is a preferable characteristic for the material used in the present invention in which the hollow inner diameter is gradually enlarged.

(4) When the FRP-made cylinder 102 is jointed to the serration portion 107 of the metal-made yoke 101, the step portion 104 is designed to be in non-contact with the FRP-made cylinder 102. Accordingly, the step portion 104 does not resist against the pressure insertion and joining of the members, and does ease the pressure insertion and joining. Further, the reliability of retraction at vehicle collision is enhanced.

(5) The metal-made yoke 101 is provided with the chamfering portion 103 extending from the leading end portion 108s to the step portion 104, and during the pressure insertion, the resistance at the leading end portion 108s is small. Accordingly, the pressure insertion and joining is easy.

(6) The step portion 104 and the serration portion 107 are connected through the inclined surface 105. By setting an appropriate angle for the inclined surface 105, as the pressure insertion advances from the step portion 104 to the serration portion 107, the step portion 104 and the pressure insertion portion inner circumferential surface 109P of the FRP-made cylinder 102 are gradually separated to facilitate the non-contact between the step portion 104 and the pressure insertion portion inner circumferential surface 109P. Accordingly, the effects of (2) and (4) can be more positively obtained.

(7) The relief portion 106 in the form of a recess is provided at the connection portion between the inclined surface 105 and the step portion 104. Accordingly, during the formation process for the inclined surface 105, the leading end of the cutting tool of the lathe machine can escape into the relief portion 106 to provide the inclined surface having a desired angle. Thus, the effect of (6) can be more positively obtained.

(8) Since the step portion 104 is formed by partially removing the addendum portions 107a of the serration portion 107, the formation of the step portion can be said to be easy.

(9) It is possible to provide the propeller shaft 110 with high concentricity.

Second Embodiment

In the first embodiment, the joining structure for the metal-made yoke 101, i.e. the first member, provided at its outer circumferential surface with the serration portion 107, and the FRP-made cylinder 102, i.e. the second member has been discussed with reference to the propeller shaft 110. In the second embodiment, a joining structure for a first member 111 having a pressure insertion end portion 113 of which is hollow and a serration portion 116 on its inner circumferential surface, and a second member 112 having a pressure insertion portion 114 will be discussed with reference to FIGS. 7 to 10.

As shown in FIG. 8, the pressure insertion end of the first member 111 is formed as the hollow-shaped, pressure insertion end portion 113, and the leading end of the pressure insertion end portion 113 is formed as a leading end portion 113s. A step portion 115 is provided to extend from the leading end portion 113s in the axial direction. The step portion 115 is further elongated in the axial direction to provide the serration portion 116.

As shown in FIG. 7, the serration portion 116 is constructed by addendum portions 116a and deddendum portions 116b. The outer shape of the step portion 115 is cylindrical, and the step portion 115 is prepared as a separate cylindrical member which is to be joined to the serration portion 116 by welding or the like.

On the other hand, the second member 112 has a pressure insertion end, i.e. the pressure insertion portion 114. A relationship between an inner diameter dimension Df of the step portion 115 and a dimension De of an outer diameter of the pressure insertion portion 114 of the second member 112 is De≧Df. As long as the dimension De of the outer diameter of the pressure insertion portion 114 of the second member 112 prior to the pressure insertion is not smaller than the dimension Df of the inner diameter of the step portion 115, the pressure insertion portion outer circumferential surface 114P can be formed into the true circle by the step portion 115 during the pressure insertion.

Further, a relationship between the dimension Df of the inner diameter of the step portion 115 and a dimension Dg of the inner diameter of the serration portion 116 is Df>Dg. As long as the dimension Dg of the inner diameter of the serration portion 116 is smaller than the dimension Df of the inner diameter of the step portion 115, cut grooves can be provided to the outer circumferential surface of the pressure insertion portion 114 by the serration portion 116.

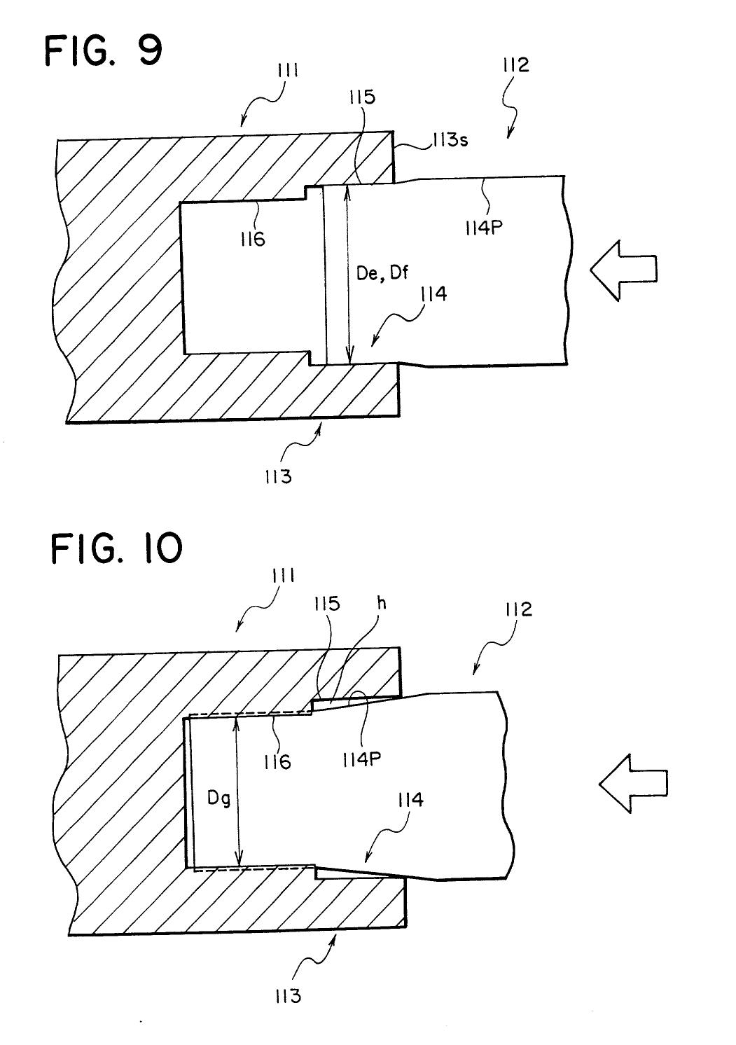

Next, with reference to FIGS. 9 and 10, a pressure insertion joining process for the first and second members will be discussed.

As shown in FIG. 9, at the first pressure insertion step in the second embodiment, the outer diameter dimension De of the pressure insertion portion 114 of the second member 112 which is low in circularity is compressively deformed to the inner diameter dimension Df of the step portion 115 by the step portion 115, thereby being formed into the true circle.

Further, as shown in FIG. 10, at the second pressure insertion step in the second embodiment, the pressure insertion portion outer circumferential surface 114P of the second member 112 is pressure-inserted into the serration portion 116 while being cut by the addendum portions 116a of the serration portion 116. Consequently, the cut grooves are formed in the pressure insertion portion outer circumferential surface 114P of the second member 112, thereby completing the pressure insertion joining.

During the pressure insertion to the serration portion 116 at the second pressure insertion step, the pressure insertion portion outer circumferential surface 114P of the second member 112 is not completely cut along the addendum portions 116a of the serration portion 116, that is, the pressure insertion is carried out while remaining non-cut portions more or less. Accordingly, a clearance h is formed between the pressure insertion portion outer circumferential surface 114P of the second member 112 and the step portion 104. Consequently, the member 112 cylindrical inner circumferential surface 112P is not contacted with the step portion 104 and thus does not produce a pressure resistance. (Even if contacted, the contact pressure is extremely low.)

Next, the effects of the present embodiment will be discussed.

(1) According to the present embodiment, when the first member 111 and the second member 112 are joined, the pressure insertion portion outer circumferential surface 114P of the second member 112 is formed into the true circle by the step portion 115 of the first member 111, and the pressure insertion outer circumferential surface 114P is joined to the serration portion 116 while making uniform the cut grooves formed by the serration portion 116. Therefore, it is possible to realize a joining structure high in joining accuracy.

(2) The second member 112 is joined to the serration portion 116 provided to the inner circumferential surface of the joining end portion 113 of the first member 111. That is, a joining structure for two members, i.e. the first member 111 provided at its inner circumferential surface with the serration portion 116 and the other second member 112 is realized.

(3) Since the step portion 115 is hollow, the contact area between the step portion 115 and the pressure insertion portion outer circumferential surface 114P of the second member 112 during the pressure insertion is large. Accordingly, the drawing and the compression can be conducted accurately, to increase product precision. It is also possible to make the formation easy by attaching a hollow portion, i.e. a separate member, to the serration portion.

In addition, in the present invention, embodiments should not be limited to those described above, and the following modification may be applied.

In the first embodiment, the step portion 104 of the metal-made yoke 101 is provided in parallel to the central axis of the metal-made yoke 101, but it may be formed in such a tapered fashion that the dimension Db of the outer diameter of the step portion 104 is made smaller toward the leading end portion 108s.

In the second embodiment, the step portion 115 of the first member 11 is provided in parallel to the central axis of the first member 111, but it may be formed in such a tapered fashion that the dimension Df of the inner diameter of the step portion 115 is made larger toward the leading end portion 114.

In the first embodiment, the serration portion 107 is provided in parallel to the central axis of the metal-made yoke 101, but may be formed in such a tapered fashion that the dimension Dc of the outer diameter of the serration portion 107 is made smaller toward the leading end portion 108s.

In the second embodiment, the serration portion 116 is provided in parallel to the central axis of the first member 111, but it may be formed in such a tapered fashion that the dimension Dg of the inner diameter of the serration portion 116 is made larger toward the leading end portion 114.

In the first embodiment, the step portion 104 is formed, remaining the deddendum portions 107b of the serration portion 107. However, depending on the height of the addendum portions 107a of the serration portion 107, the addendum portions 107a of the serration portion 107 may be completely removed to present a perfect cylindrical shape as shown in FIG. 7.

A plurality of members may be joined alternately, for example, the second member 112—the first member 111—second member 112—the first member 111.

Both of the first member 111 and the second member 112 may be formed as hollow members.

Third Embodiment

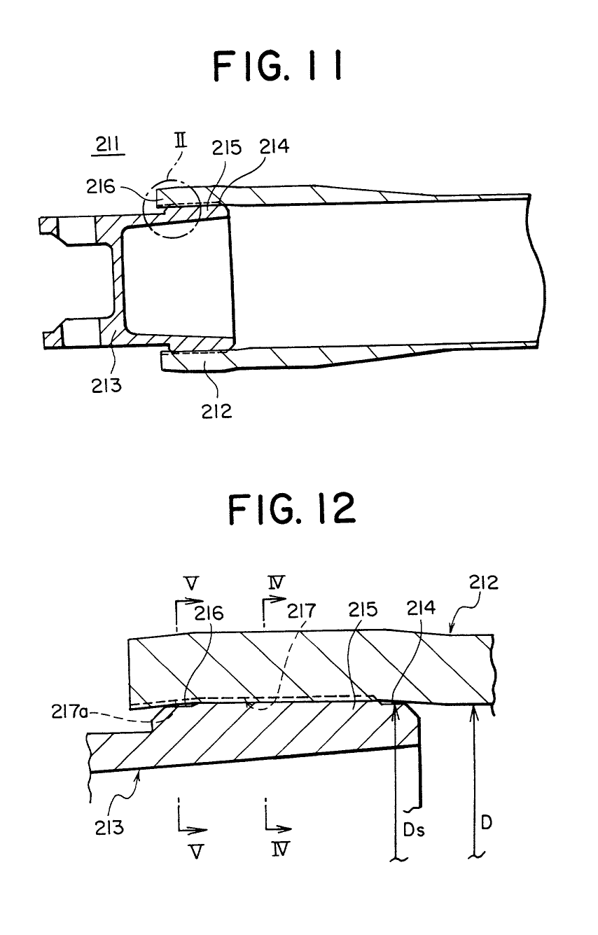

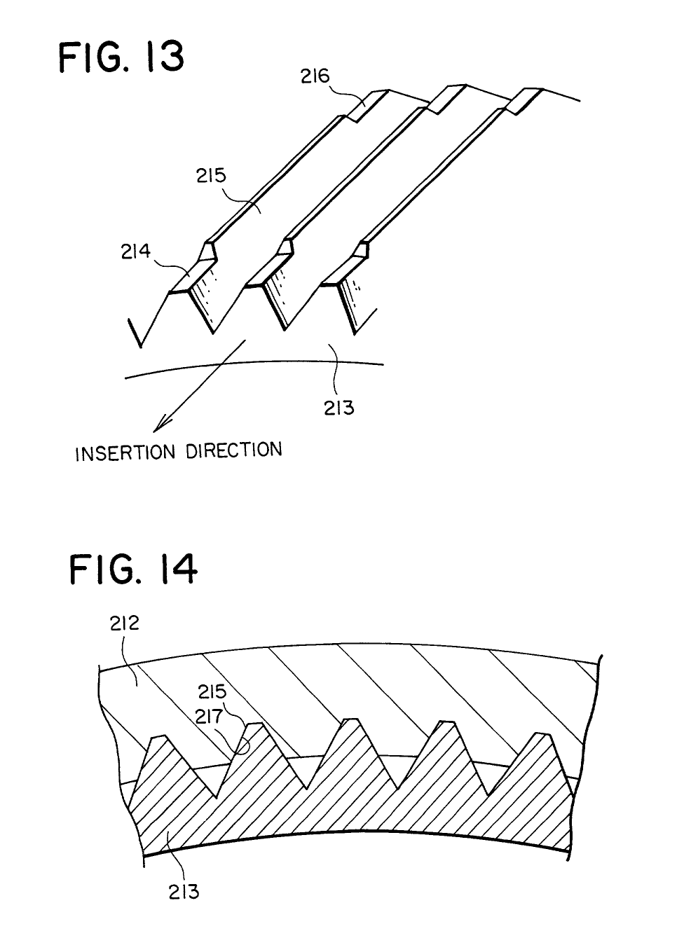

FIG. 11 shows the cross-section of a propeller shaft according to a third embodiment of the present invention. The propeller shaft 211 includes, as a second member, a FRP cylinder 212 made up of a cylindrical member formed of FRP, and as a first member, a metal yoke 213 formed of metal and inserted into the FRP cylinder 212. As shown in FIGS. 12 and 13, of the outer circumferential surface of the insertion portion of the metal yoke 213, the insertion direction forward end portion is formed with a guide surface 214. The portion of the metal yoke 213 where the guide surface 214 is provided has a diameter slightly smaller than or substantially equal to a hole diameter concerning the inner circumferential surface of the FRP cylinder 212, and extends in the same shape as the inner circumferential surface, to thereby facilitate the alignment when the metal yoke 213 is concentrically inserted into the FRP cylinder 212. This ensures the concentricity at the start of the insertion of the metal yoke 213 and the FRP cylinder 212. Of the outer circumferential surface of the insertion portion of the metal yoke 213, the rear of the insertion direction behind the guide surface 214 is formed with serration teeth 215. The serration teeth 215 extend substantially along the insertion direction of the metal yoke 213. The diameter of he metal yoke 213 at the addendum portions of the serration teeth 215 is set to be slightly larger than the hole diameter concerning the inner circumferential surface of the FRP cylinder 212. Further, of the outer circumferential surface of the insertion portion of the metal yoke 213, the rear of the insertion direction behind the serration teeth 215 is formed with an inclination suppressing surface 216. The portion of the metal yoke 213 where the inclination suppressing surface 216 is provided also has a diameter slightly smaller than or substantially equal to the hole diameter concerning the inner circumferential surface of the FRP cylinder 212, and extends in the same shape as the inner circumferential surface. Further, the diameter of the inclination suppressing surface 216 is substantially equal to the diameter of the guide surface 214 so as to enhance the productivity in formation by cutting.

Next, the connection between the FRP cylinder 212 and the metal yoke 213 will be discussed. First of all, the end portion of the metal yoke 213 is abutted against the end portion of the FRP cylinder 212 to initiate the insertion of the metal yoke 213 into the FRP cylinder 212. At this time, since the guide surface 214 and the inner circumferential surface of the FRP cylinder 212 extend substantially in parallel to each other and have the diameters substantially similar to each other, the metal yoke 213 enters into the FRP cylinder 212 concentrically and straightly. Subsequently, the serration teeth 215 of the metal yoke 213 are also inserted into the FRP cylinder 212. The diameter of the metal yoke 213 at the addendum portions of the serration teeth 215 is larger than the hole diameter concerning the inner circumferential surface of the FRP cylinder 212, so that the serration teeth 215 enter into the interior of the cylinder while enlarging the FRP cylinder 212. That is, the FRP cylinder 212 is elastically deformed and enlarged at its interior portions where the serration teeth 215 are located. During this pressure insertion, the serration teeth 215 enter while cutting the inner circumferential surface of the FRP cylinder 212. Consequently, as shown in FIG. 14, cut grooves 217 of such a shape as to engage the serration teeth 215 are formed in the inner circumferential surface of the FRP cylinder 212. By the serration teeth 215 and the grooves 217, the FRP cylinder 212 and the metal yoke 213 are connected in a torque transmissible fashion. As described above, since the outer diameter Ds of the guide surface 214 is set to be substantially equal to or slightly larger than the dimension D of the inner diameter of the FRP cylinder 212, more specifically, a difference between the outer diameter Ds and dimension D of the inner diameter is set to be 0 to 0.1 mm, the FRP cylinder 212 is conformed to the guide surface 214 to be formed into the true circle. Subsequently, the serration teeth 215 can be pressure-inserted into the FRP cylinder 212 concentrically and straightly to make uniform the depth of the cut grooves, formed in the FRP cylinder 212 inner surface, in the circumferential direction, thereby eliminating the eccentricity.

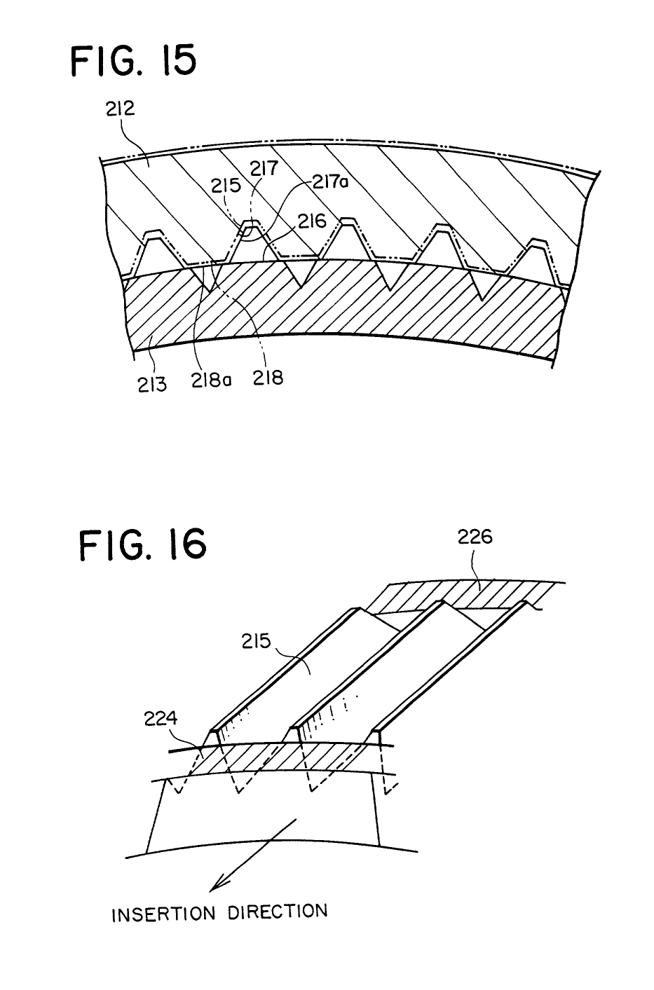

Further, as shown in FIG. 12, the inclination suppressing surface 216 of the metal yoke 213 is also inserted into the FRP cylinder 212. Since the diameter of the metal yoke 213 portion where the inclination suppressing surface 216 is provided is smaller than that of the metal yoke 213 portion at the addendum portions of the serration teeth 215, the portion of the FRP cylinder 212 enlarged as a consequence of the passage of the serration teeth 215 is elastically restored and returned to the original hole diameter when the serration teeth 215 has passed and the inclination suppressing surface 216 has been inserted. That is, as shown in FIG. 15, the portion 217a of the groove 217 where the serration tooth 215 has been passed and the inclination suppressing surface 216 is present is elastically restored, so that it is narrower in width in the circumferential direction and shallower in depth than a portion of the groove 217 where the serration tooth 215 is engaged. In other words, the inner circumferential surface 218a between two groove portions 217a which is the location where the serration teeth 215 have been passed is elastically restored, so that it is wider in width in the circumferential direction and smaller in hole diameter than the inner circumferential surface 218 between the two grooves 217 at location where the serration teeth 215 are engaged. Consequently, the inner circumferential surface 218a between the two groove portions 217a which is the location where the serration teeth 215 have passed is almost in non-contact with or is lightly in surface-contact with the inclination suppressing surface 216 of the metal yoke 213.

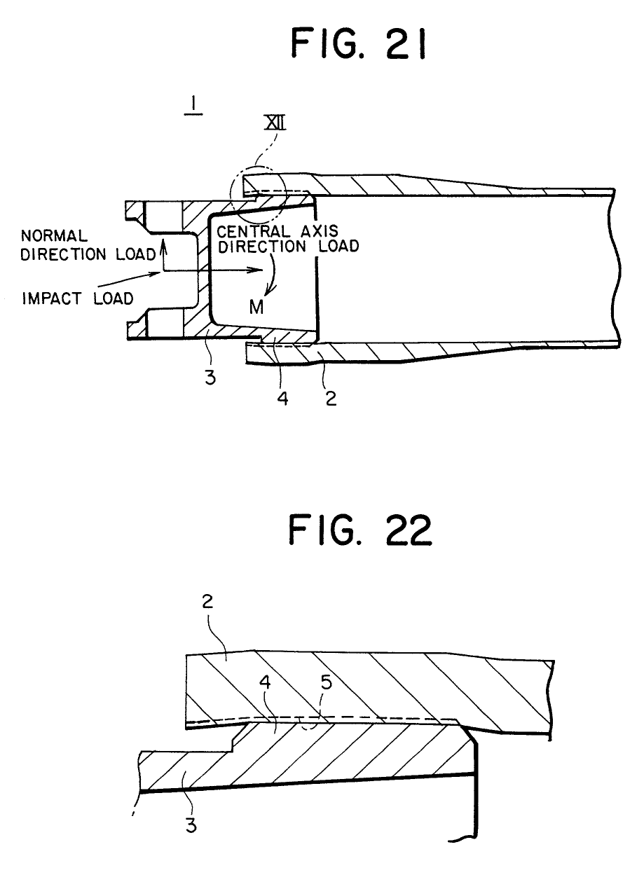

Next, a case in which an impact load in a compression direction acts on the propeller shaft 211 by collision of an automotive vehicle provided with the propeller shaft 211 will be discussed. First, in a case where an impact load acts on the propeller shaft 211 in a direction parallel to an axis thereof, the metal yoke 213 is straightly and deeply retracted further into the FRP cylinder 212 while enlarging the FRP cylinder 212 so that the entire length of the propeller shaft 211 is shortened, thereby absorbing the impact. On other hand, in a case where an impact load acts on the propeller shaft 211 in a direction inclined with respect to the propeller shaft axis direction, as explained with reference to FIG. 21, the component of the impact load in the axis direction causes the metal yoke 213 to be retracted into the FRP cylinder 212, but the component of the impact load in the direction normal to the axis direction generates the moment for rotating the metal yoke 213. However, in the present embodiment, since the inner circumferential surface 218a of the FRP cylinder 212 is almost in non-contact with or lightly in surface-contact with the inclination suppressing surface 216 of the metal yoke 213 behind the serration teeth 215 in the insertion direction, if the inclined impact load is applied, the inner circumferential surface 218a and the inclination suppressing surface 216 are completely surface-contacted with each other, whereby the inclination of the metal yoke 213 by the moment can be suppressed. Accordingly, even if the inclined impact load is applied, the metal yoke 213 is straightly and concentrically retracted into the FRP cylinder 212, and in contrast to the related art, the leading ends of the serration teeth do not cut the inner surface of the FRP cylinder, and therefore the retracting force is not increased.

Fourth Embodiment

As a fourth embodiment, in place of the guide surface 214 and the inclination suppressing surface 216, each separated in the circumferential direction, in the metal yoke 213 in the propeller shaft according to the third embodiment, an annular guide surface 224 and an annular inclination suppressing surface 226, each continuous in the circumferential direction, may be provided as shown in FIG. 16. According to this inclination suppressing surface 226, an area of the inclination suppressing surface is enlarged to increase a contactable region, and consequently, the surface contact region between the inner circumferential surface of the FRP cylinder 212 and the inclination suppressing surface 226 of the metal yoke 213 is increased, thereby providing more remarkable retraction force suppressing effect. In addition, a difference between the outer diameter Ds of the guide surface 224 and the dimension D of the inner diameter of the FRP cylinder 212 can be set to be 0 to 0.1 mm similarly to the third embodiment.

Fifth Embodiment

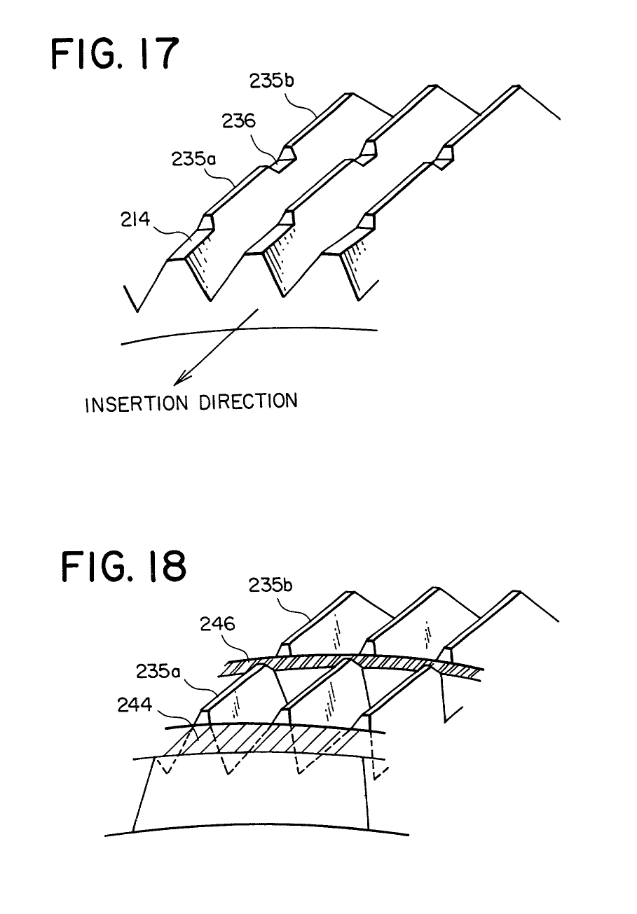

As a fifth embodiment, for the metal yoke 213 in the propeller shaft according to the third embodiment, not a single set of serration teeth but two sets of serration teeth may be provided to be spaced in the insertion direction as shown in FIG. 17. First serration teeth 235a located forwardly in the insertion direction are positioned behind the guide surface 214 in the insertion direction. An inclination suppressing surface 236 is provided behind the first serration teeth 235a in the insertion direction. Further, second serration teeth 235b are provided behind the inclination suppressing surface 236 in the insertion direction.

Sixth Embodiment

As a sixth embodiment, in place of the guide surface 214 and the inclination suppressing surface 236, each separated in the circumferential direction, in the metal yoke 213 in the propeller shaft according to the fifth embodiment, an annular guide surface 244 and an annular inclination suppressing surface 246, each continuous in the circumferential direction, may be provided as shown in FIG. 18. In addition, a difference between the outer diameter Ds of the guide surface 244 and the dimension D of the inner diameter of the FRP cylinder 212 can be set to be 0 to 0.1 mm similarly to the third embodiment.

Seventh Embodiment

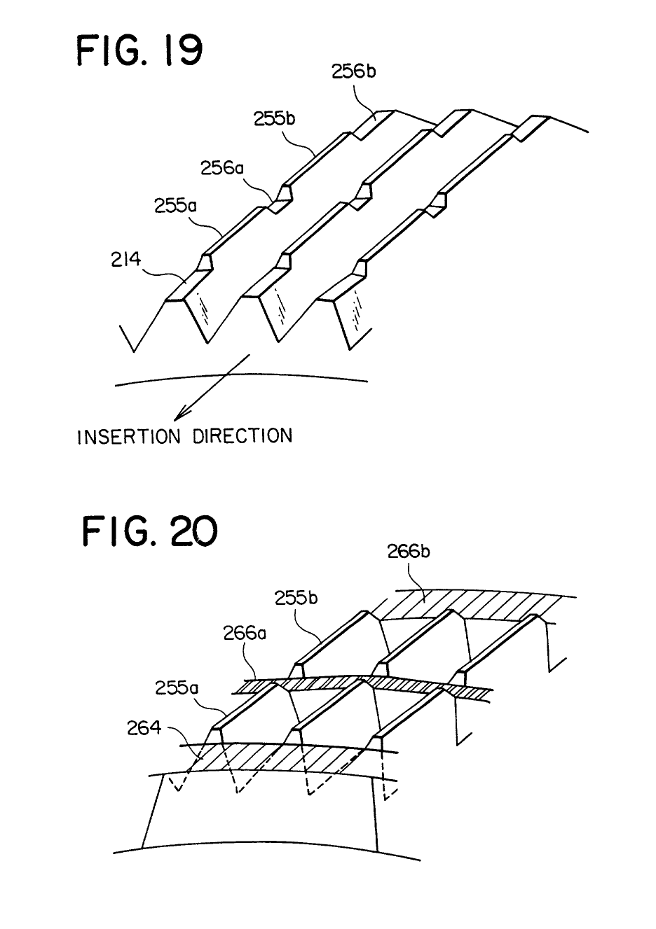

As a seventh embodiment, for the metal yoke in the propeller shaft according to the third embodiment, not a single set of serration teeth and a single inclination suppressing surface, but two sets of serration teeth may be provided to be spaced in the insertion direction and further two inclination suppressing surfaces may be provided to be spaced in the insertion direction, as shown in FIG. 19. First serration teeth 255a located forwardly in the insertion direction are positioned behind the guide surface 214 in the insertion direction. A first inclination suppressing surface 256a is provided behind the first serration teeth 255a in the insertion direction. Second serration teeth 255b are provided behind the first inclination suppressing surface 256a in the insertion direction. Further, a second inclination suppressing surface 256b is provided behind the second serration teeth 255b in the insertion direction. According to this arrangement, since two inclination suppressing surfaces 256a and 256b are provided behind the respective serration teeth 255a and 255b to be separated in the insertion direction, the inclination suppressing effect for the metal yoke can be positively enhanced.

Eighth Embodiment

As an eighth embodiment, in the metal yoke of the propeller shaft according to the seventh embodiment, in place of the guide surface 214 and the two inclination suppressing surfaces 256a and 256b, each separated in the circumferential direction, an annular guide surface 264 and two annular inclination suppressing surfaces 266a and 266b, each continuous in the circumferential direction, may be provided as shown in FIG. 20. In addition, a difference between the outer diameter Ds of the guide surface 264 and the dimension D of the inner diameter of the FRP cylinder 212 can be set to be 0 to 0.1 mm similarly to the third embodiment.

According to the first aspect of the invention, when the serration portion of the first member is joined to the second member, the surface contact portion of the first member is surface-contacted with the second member. Consequently, the joining high in concentricity is possible without relative inclination.

According to the second aspect of the invention, when the first member is joined to the second member, the pressure insertion portion of the second member is formed by the step portion of the first member into a true circle, and the depth of cut grooves formed by the serration portion is made uniform, and the second member is joined to the serration portion in this state. Accordingly, the joining structure high in joining accuracy can be realized, and it is possible to manufacture, for example, a drive shaft for torque transmission.

According to the third aspect of the invention, the joining structure for two members in which the serration portion is provided to the outer circumferential surface of the first member is realized.

According to the fourth aspect of the invention, the joining structure for two members in which the serration portion is provided to the inner circumferential surface of the first member is realized.

According to the fifth aspect of the invention, the metal member is joined to the resin member, and thus it is possible to provide a joining member light in weight as a whole.

According to the sixth aspect of the invention, the step portion is formed to be in non-contact with the second member, and thus the step portion does not produce resistance against the pressure insertion and joining, thereby easing the pressure insertion and joining. Further, the reliable retraction at the vehicle collision can be secured.

According to the seventh aspect of the invention, the presence of the chamfering portion eases the pressure insertion and joining.

According to the eighth aspect of the invention, the step portion and the serration portion is connected together through the inclined surface. Therefore, by setting an appropriate angle for the inclined surface, the step portion and the second member are gradually separated from each other to readily provide the non-contact therebetween.

According to the ninth aspect of the invention, the presence of the relief portion makes it possible to form the inclined angle at a desired angle.

According to the tenth and eleventh aspects of the invention, the tapered step portion eases the pressure insertion and joining.

According to the twelfth and thirteenth aspects of the invention, the tapered serration portion eases the pressure insertion and joining.

According to the fourteenth aspect of the invention, the step portion is formed by removing the addendum portions of the serration portion. Therefore, formation of the step portion is relatively easy.

According to the fifteenth aspect of the invention, since the contact area between the step portion and the pressure insertion portion during the pressure insertion is larger, the drawing and compression can be executed accurately, thereby increasing the product precision. Further, the formation can also be made easy by attaching a hollow portion, i.e. a separate member, to the serration portion.

According to the sixteenth aspect of the invention, since the FRP-made cylinder is joined to the metal-made cylinder in a state that the circularity thereof is high, it is possible to provide a propeller shaft which is uniform in depth of the cut grooves and high in accuracy (concentricity).

According to any one of the seventeenth to twentieth aspects of the invention, if the inclined impact load is applied, the inner circumferential surface of the second member and the inclination suppressing surface of the first member are completely surface-contacted with each other behind the serration teeth in the insertion direction, to thereby suppress the inclination of the first member caused by the moment. Therefore, even if the inclined impact load is applied, the first member is retracted into the second member concentrically and straightly, the inner surface of the second member is prevented from being cut, and the retracting force is not increased.

What is claimed is:

1. A joining structure comprising:
a first member having a serration portion; and
a second member to be joined to the serration portion,
wherein the first member has a surface contact portion at location adjacent to the serration portion to be surface-contacted with the second member.

2. A joining structure according to claim 1, wherein:
the serration portion is provided at a pressure insertion end portion of the first member;
the second member has a pressure insertion portion to be pressure-inserted and joined to the serration portion;
the surface contact portion includes a step portion provided between a leading end portion of the pressure insertion end portion and the serration portion to extend in an axial direction; and
a diameter of the step portion is equal to a diameter of the pressure insertion portion or set between the diameter of the pressure insertion portion and a diameter of the serration portion.

3. A joining structure according to claim 2, wherein:
the serration portion is provided to an outer circumferential surface of the pressure insertion end portion;
the pressure insertion portion of the second member is hollow; and
an outer diameter of the step portion is not smaller than an inner diameter of the pressure insertion portion, and is smaller than an outer diameter of the serration portion.

4. A joining structure according to claim 2, wherein:
the pressure insertion end portion of the first member is hollow;
the serration portion is provided to an inner circumferential surface of the pressure insertion portion; and
an inner diameter of the step portion is not larger than the pressure insertion portion, and is larger than an inner diameter of the serration portion.

5. A joining structure according to claim 2, wherein:
the first member is a metal member; and
the second member is a resin member.

6. A joining structure according to claim 2, wherein:
after the second member is joined to the serration portion of the first member, the step portion is in non-contact with the second member.

7. A joining structure according to claim 2, wherein:
the first member has a chamfering portion extended from the leading end portion to the step portion.

8. A joining structure according to claim 2, wherein:
the step portion is connected to the serration portion through an inclined surface.

9. A joining structure according to claim 2, wherein:
the step portion is connected to the serration portion through an inclined surface; and
a relief portion in the form of a recess is provided to a connection portion between the inclined surface and the step portion.

10. A joining structure according to claim 3, wherein:
the step portion is tapered so that the outer diameter of the step portion is made smaller toward the leading end portion.

11. A joining structure according to claim 4, wherein:
the step portion is tapered so that the inner diameter of the step portion is made larger toward the leading end portion.

12. A joining structure according to claim 3, wherein:
the serration portion is tapered so that the outer diameter of the serration portion is made smaller toward to the leading end portion.

13. A joining structure according to claim 4, wherein:
the serration portion is tapered so that the inner diameter of the serration portion is made larger toward the leading end portion.

14. A joining structure according to claim 2, wherein:
the step portion is formed by partially removing addendum portions of the serration portion.

15. A joining structure according to claim 2, wherein:
the step portion is formed cylindrically between the leading end portion and the serration portion.

16. A joining structure according to claim 2, wherein:
the first member is a metal-made yoke of a propeller shaft; and
the second member is an FRP-made cylinder of the propeller shaft.

17. A propeller shaft having the joining structure according to claim 1, in which the second member has a hollow portion at an end portion, and the first member is inserted into the hollow portion, wherein:
the serration portion is provided to an outer circumferential surface of an insertion portion of the first member;
grooves are provided to an inner circumferential surface of the hollow portion to engage the serration portion; and
the surface contact portion includes an inclination suppressing surface that is provided on the outer circumferential surface of the insertion portion and behind the serration portion in an insertion direction, and that is surface-contacted with the inner circumferential surface of the hollow portion to suppress an inclination of the first member during insertion.

18. A propeller shaft according to claim 17, wherein:
two serration portions are provided to be spaced in the insertion direction as first and second serration portions; and
the inclination suppressing surface is provided behind either one or both of the first serration portion located forwardly in the insertion direction and the second serration portion located rearward in the insertion direction.

19. A propeller shaft according to claim 17, wherein:
the surface contact portion includes a guide surface that is provided to the outer circumferential surface of the insertion portion at its forward end and forwardly of the serration portion in the insertion direction, and that is surface-contacted with the inner circumferential surface of the hollow portion to ensure concentricity of shaft members during start of insertion.

20. A propeller shaft according to claim 19, wherein:
the guide surface and the inclination suppressing surface are substantially equal to each other in diameter.
